(19) United States
(12) Patent Application Publication
(10) Pub. No.: US 2010/0001537 A1
(43) Pub. Date: Jan. 7, 2010

(54) DEVICE AND METHOD FOR PRODUCING ELECTRICITY

(76) Inventor: Didier Galvez Thiange, Gesves (BE)

Correspondence Address: SUGHRUE MION, PLLC, 2100 PENNSYLVANIA AVENUE, N.W., SUITE 800, WASHINGTON, DC, 20037, US

(21) Appl. No.: 12/447,559

(22) PCT Filed: Oct. 30, 2007
(86) PCT No.: PCT/EP07/61698

§ 371 Date: Apr. 28, 2009

(30) Foreign Application Priority Data
Oct. 31, 2006 (EP) 06123256.7

(51) Int. Cl. H02K 7/18

(52) U.S. Cl. 290/1 R

(57) ABSTRACT

Electricity production method comprising a movement in water of a plurality of movable elements (1) integral with respect to movement, each having a first compartment (2) containing at least one dissolved gas and a second compartment (3), connected to each other, this movement comprising, for each movable element (1), a descent of the said at least one movable element (1) to a predetermined depth under the effect of gravity, putting the two compartments in communication, ascent of the said at least one movable element (1) by expansion of the said gas in the said second compartment (3), and conversion of this movement into electrical energy.

The present invention relates to a method of producing electricity, in particular to a device for producing electricity using water pressure, gravity and buoyancy to generate a movement for driving a generator.

The invention procures a method that does not require extensive infrastructure, without excessive civil engineering, which does not disfigure the surrounding landscape, is clean, using only natural resources, without the production of carbon oxides, and of remarkable simplicity.

According to the invention, a method of producing electricity is provided comprising:
movement in water of a plurality of movable elements integral with respect to movement, each having a first compartment and a second compartment connected to each other so as to allow alternately isolation and communication with each other, this movement comprising, for each movable element:
   descent to a predetermined depth, during which the first compartment is isolated from the said second compartment, comprising:
      opening of a passage to the outside of the said first compartment, which thus contains water in which the said movable element is immersed and in which a gas is dissolved, the gas in the said first compartment having, at least at the said predetermined depth, a predetermined pressure, the said movable element having at the said predetermined depth a specific gravity corresponding to the said predetermined pressure, and
      closure of the said passage at the said predetermined depth, the said descent being simultaneous with an ascent of at least one other movable element,
   a putting of the said first compartment in communication with the said second compartment, at the said predetermined depth,
   ascent of the said at least one first movable element initially by driving and then by progressive reduction of the water pressure with expansion of the said gas in the said second compartment and a reduction of the said specific gravity, the said ascent being simultaneous with a descent of the said at least one other movable element, and
a conversion of this movement into electrical energy.

According to the invention, a plurality of movable elements move in closed circuit and are integral with respect to movement, generating a movement that can be transmitted to a generator for the purpose of producing electricity. When a movable element descends, another rises, and so on.

The movable elements drive each other mutually and having an even number of movable elements placed symmetrically makes it possible to achieve a state of equilibrium. The weights cancel each other out and all that remains is the greater buoyancy on the movable elements rising by reduction of the specific gravity.

The first movable element according to the method in accordance with the invention descends in the water under the effect of its own weight and therefore gravity. The movable elements are designed to suffer the least possible friction and consequently for their descent are practically not restricted (neither by friction nor by the viscosity of the water). Simultaneously, another movable element rises. Consequently the weight of the two movable elements placed symmetrically cancel each other out and the buoyancy is exerted with a greater force on the rising element than on the descending element. The movable element situated at the predetermined depth is subjected to the pressure exerted on it and contains a quantity of water saturated (or close to saturation) with dissolved gas (equilibrium state) which was taken off at the predetermined depth and consequently contains a quantity of pressurised gas contained in the first compartment and kept dissolved by the pressure of the water. When a movable element arrives at the said predetermined depth, is has a kinetic energy that is equal to the potential energy that it had before descent. The kinetic energy that the movable element has, as well as the fact that the weight forces of this movable element and of the other movable element cancel each other out, procures for it sufficient inertia to drive it in its ascent conjointly with the descent of another movable element.

Between the descent and the ascent of each movable element, the first compartment is put in communication with the second compartment. Consequently, by offering a larger volume to the gas dissolved in the water (pressurised gas), the dissolved gas will have a tendency to volatilise when the pressure decreases (on gradually going up again) and to occupy every available space, which causes ascent of the said movable element. This is because the pressure exerted on the movable element decreases at the same time as the depth decreases and, since the communication between the two compartments offers a larger volume to the pressurised gas, it can then occupy the entire space. The dissolved gas consequently undergoes exsolution and the gas molecules mixed with the water taken off at the said predetermined depth escape towards the available space. The density of the first movable element decreases since, for a given mass, the volume of the movable element increases and the latter therefore rises towards the surface again. As the movable element rises, the less is the pressure exerted on it and the more the movable element rises. This is because the pressurised gas is free to occupy a large volume since space has been offered to it following the first and second compartments being put in communication. In addition, as the external pressure, and therefore the pressure that is exerted on the pressurised gas, decreases with the rising, the pressurised gas is less and less compressed and therefore passes into the second compartment in the expanded or exsolved state. This drives the movable element in question upwards (like a submerged balloon rising to the surface). This ascent and descent movement of the movable elements generates a movement that is transmitted to a generator for the production of electricity.

This is therefore an entirely clean method that uses gases dissolved in water in a natural manner, produces no carbon oxides and absolutely does not harm the environment. One of the advantageous aspects lies in the fact that it is principally air that is extracted from the depths of the sea and consequently the gas released in the atmosphere is mainly air. When other gases are collected, the invention makes provision for collecting them for the purpose of recovering them (for example methane).

However, very surprisingly, it was shown according to the invention that the quantity of dissolved gas was much greater than that which was expected theoretically. This is because the quantity of air that is in solution in water at the same predetermined depth is very great and, as soon as it is enabled to leave the liquid phase by offering it a larger volume (when the first and second compartments are put in communication) and reducing the pressure of the water solely because of the reduction in the height of the water column, the dissolved gas escapes into the second compartment, which drives the movable element upwards.

It has in fact surprisingly been found (see example described simultaneously with FIG. 9) that, in the case of surface water, initially subsaturated with gas, the surface water becomes denser because it dissolves air. This increase in density has been observed by leaving a quantity of water in a receptacle and carrying out repeated weighing. The weight of the whole increases over time. If there had been no increase in density because of the dissolution of gas (incorporation of molecules in the molecular lattice of the liquid water) and through the fact that the whole is in this same gas that dissolves (the receptacle containing water is in contact with atmospheric air), the buoyancy would very exactly compensate for this dissolution.

Since this surface water increase in density, it flows into the less dense water (the subjacent water) and this less dense water replaces it on the surface. In descending into the less dense water, the pressure that is exerted on the latter is higher than on the surface, and there is therefore a compression phenomenon that occurs and heating. The latter results in a release of the incorporated gas, which is directly captured by the surrounding water, which is also colder and therefore more inclined to absorb gas. In this way the density of the surrounding water increases and it flows until it encounters water that has the same density. Compression occurs once again and the phenomenon will continue until saturation is obtained for the pressure corresponding to each depth. There is therefore a supply of gas from the depths of the water.

It is therefore for this reason that the quantity of air dissolved in the water at a predetermined depth is higher than what was expected through existing models that use a linear model for approximating this quantity based on Henry's law. In addition, these gases, being mixed with water, are limited by this water in their agitation and must therefore be present in larger quantities in order to exert the same pressure as if they were in gaseous form. They act in fact as if they were alone (Dalton's law).

Advantageously, the method according to the invention comprises, between the said descent and the said ascent of each movable element, a substantially horizontal movement of the said movable element during which the said putting in communication of the two compartments takes place, simultaneous or not with the isolation of the whole from the external environment and/or between the said ascent and the said descent of each movable element, a substantially horizontal movement of the said movable element during which the said isolation of the said second compartment with respect to the first compartment takes place, simultaneously or not with the opening of the first compartment towards the external environment.

This makes it possible for the pressure exerted on the movable element when the first compartment and second compartment come into communication to be constant throughout the period of putting in communication.

In a preferential embodiment, the method comprises an agitation of the water contained in the said first compartment so as to facilitate the expansion of the gas dissolved in this water. The agitation can be carried out directly in the first compartment, or throughout the ascent by means of external and/or internal agitation devices.

Preferably the expanded gas is expelled from the said movable element after the ascent of the said movable element. The expanded gas is therefore released under water and rises to the surface in order to be released in the air lying over the surface of the water or is released on the surface of the water.

Advantageously, the method according to the invention also comprises, before the said ascent (and therefore at the predetermined depth and pressure), an introduction of a quantity of air also under pressure through a porous material, aimed at facilitating the exsolution of the molecules of dissolved gas, incorporated in the water molecules that have been taken off at the said depth.

Other embodiments of the method according to the invention are indicated in the accompanying claims.

The invention also relates to an electricity production device comprising;
a transport track immersed in the water comprising at least one descent section and one ascent section,
a plurality of movable elements (1) integral with respect to movement with the said transport track, each movable element comprising a first and second compartment and connection means affording communication or isolation of these compartments with respect to each other and the surrounding environment, and
means of transmitting movement from the said movable element to at least one generator capable of converting this movement into electrical energy by absorption of the energy generated by the buoyancy (surface gearing down at the link between the system and a generator).

It is clear from this that the device according to the invention comprises only clean elements, not giving rise to any pollutant and in particular simple to implement, which use the force of gravity, buoyancy and the water pressure at a predetermined depth.

Other embodiments of the device according to the invention are indicated in the accompanying claims.

Other features, details and advantages of the invention will emerge from the description given below, non-limitatively and referring to the accompanying drawings.

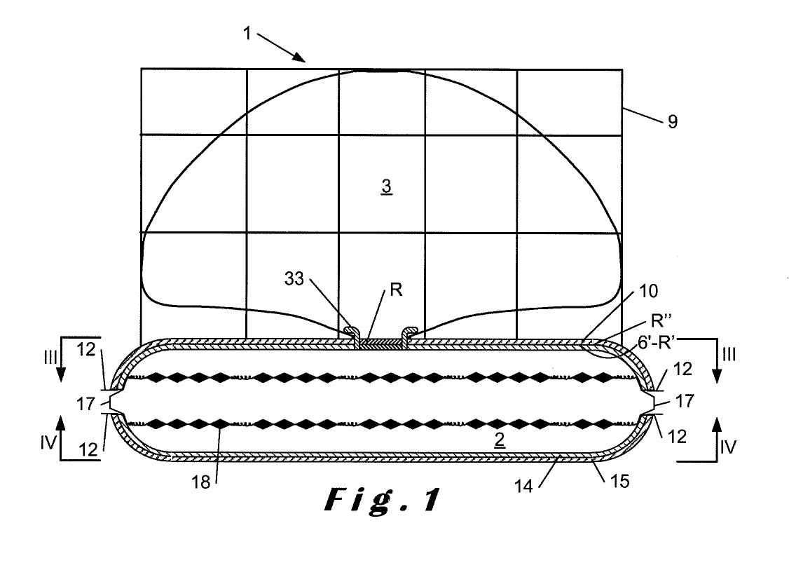

FIG. 1 is a view in section of a movable element of one embodiment of the device according to the invention.

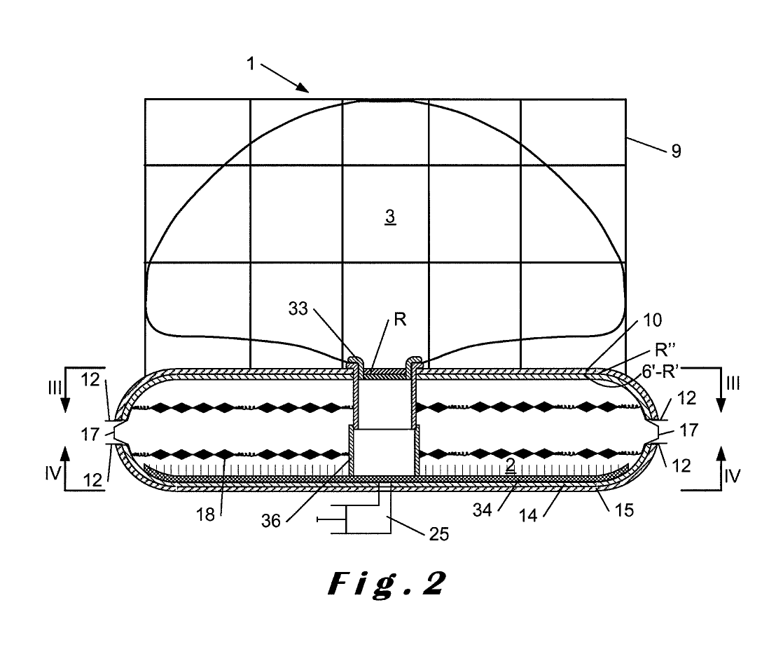

FIG. 2 is a view in section of a movable element of a variant embodiment of the device according to the invention.

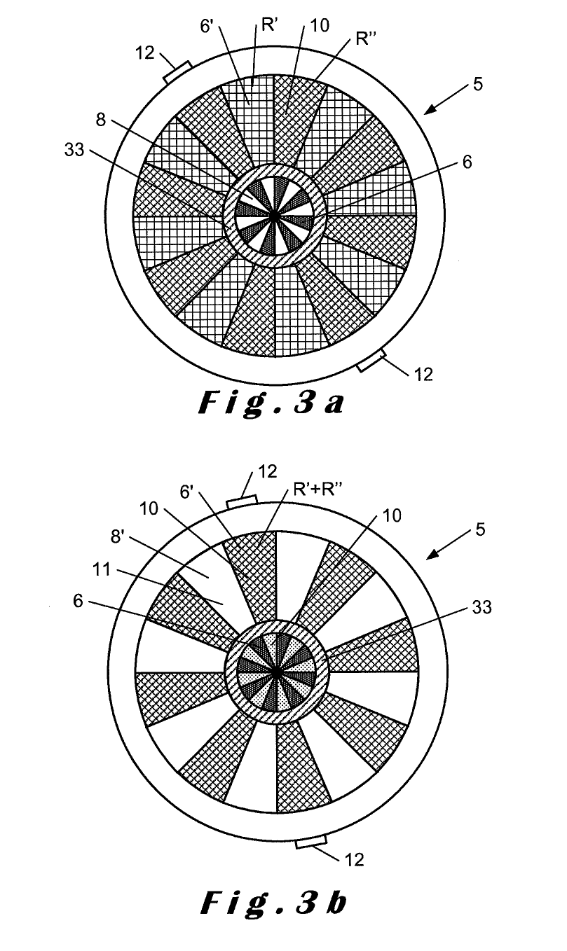

FIGS. 3A and 3B are views in section along the line III-III in FIG. 1 or 2 of the connection means and of the first closure means between the first compartment and the second compartment of the movable element illustrated in FIG. 1 or 2, respectively in the open position (FIG. 3A) and in the closed position (FIG. 3B).

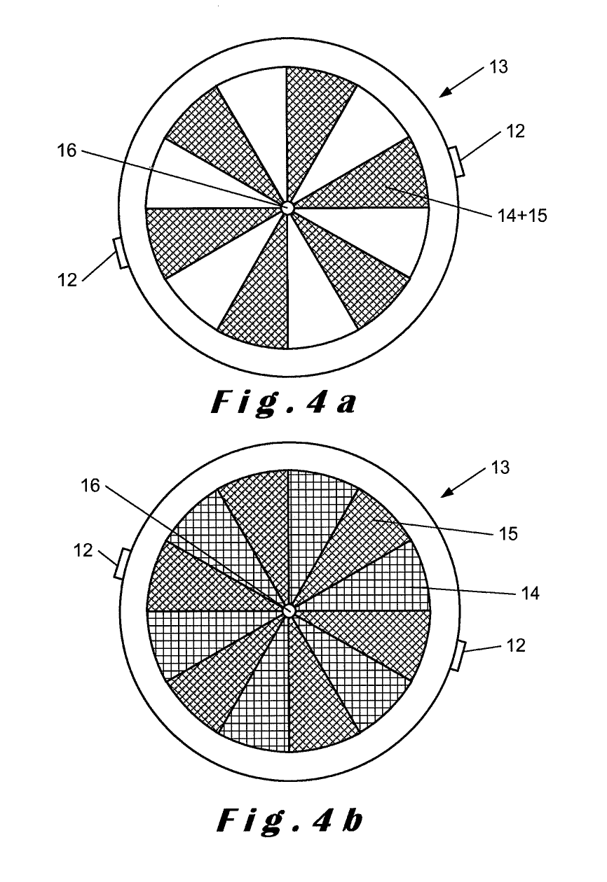

FIGS. 4a and 4B are views in section along the line IV-IV in FIG. 1 or 2 of the second closure means between the first compartment and the surrounding water of the movable element illustrated in FIG. 1 or 2 respectively in the open position (FIG. 4A) and in the closed position (FIG. 4B).

FIG. 5 is a perspective view of the device according to the invention comprising two movable elements as illustrated in FIG. 1.

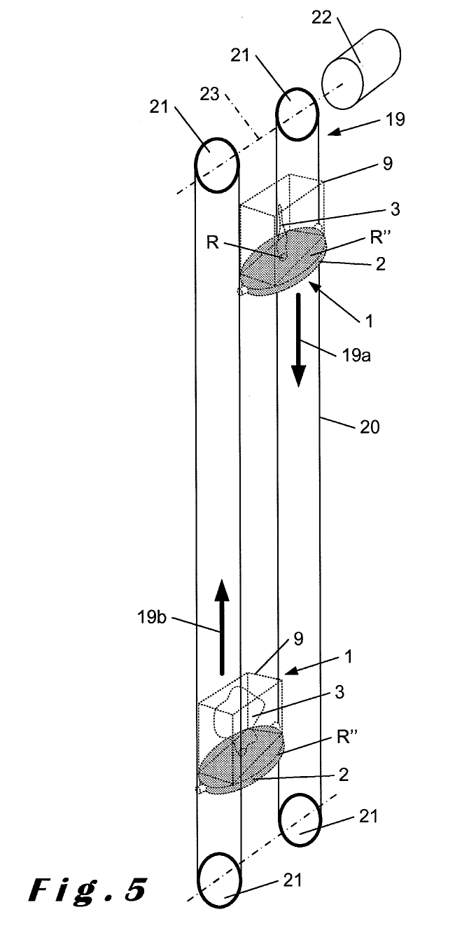

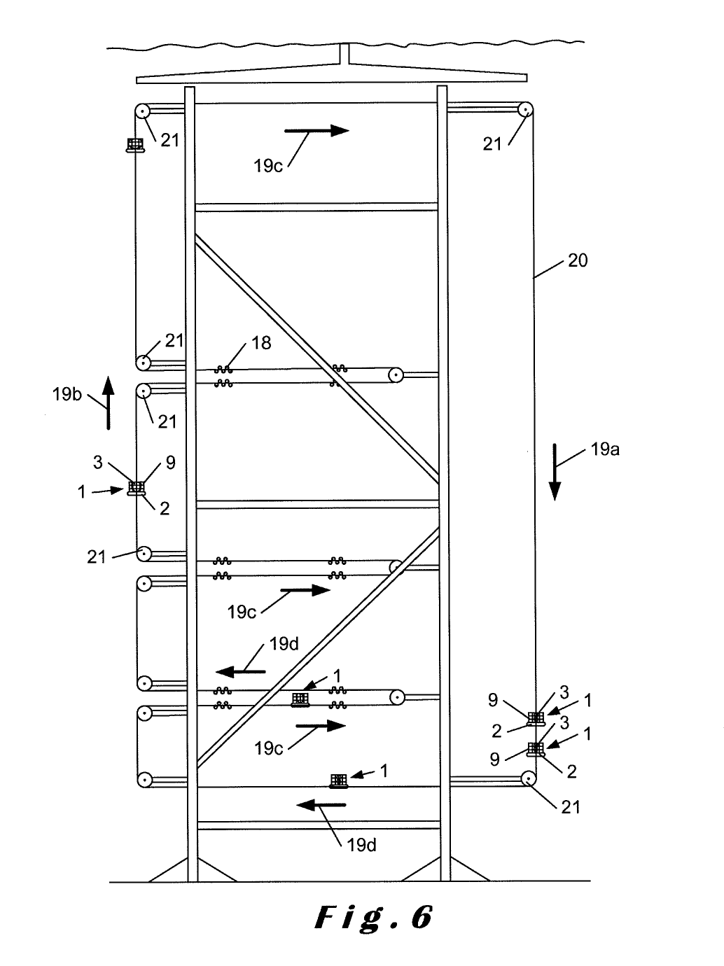

FIG. 6 is a front view of a particularly preferential embodiment of the device according to the invention comprising a plurality of movable elements as illustrated in FIG. 1.

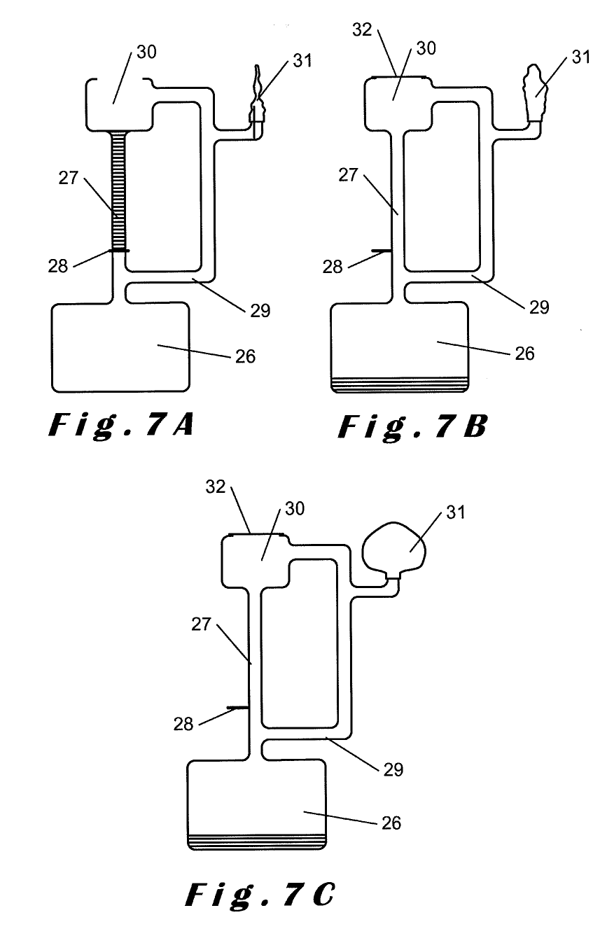

FIG. 7 is a schematic representation of an experimental device for illustrating the exsolution phenomenon.

In the figures, the identical or similar elements bear the same references. As can be seen in FIG. 1, the movable element 1 comprises a first compartment 2 and a second compartment 3. The second compartment 3 is an extensible element protected by a protective structure of the sleeve type 9. The protective structure of the sleeve type 9 can have a square, rectangular, triangular, round or oval transverse section or other imaginable forms such as a hexagon, a pentagon, etc.

The movable element illustrated in FIG. 1 comprises a connection means 5 (a rotary drawer consisting of the parts R, R′), and a first closure means (part R″ of a rotary drawer). The first closure means R″ is illustrated with the connection means 5 in FIGS. 3A and 3B.

The part R′ comprises eight fins 6′ and eight orifices 8′ in its circumferential part, which extends from the zone 33 where the second compartment (3) is attached to the first compartment (2) as far as the circumference of the part R′. Preferably the part R′ has substantially the same diameter as the first compartment 2 to which it is secured. The part R also comprises eight fins 6 and eight orifices 8 in its central part extending from the centre to the attachment zone 33. The part R of the said rotary drawer has a diameter identical to that of the narrowing of the attachment zone 33 illustrated in FIG. 1 between the first compartment 2 and the second compartment 3.

The parts R′ and R are mutually integral with the attachment zone 33.

Under the connection means 5 there is a part R″ also comprising eight fins 10 and eight orifices 11. The part R″ is the movable part of the aforementioned rotary drawer, also has substantially the same diameter as the said first compartment 2 and makes it possible to open the passage of the surrounding water into the first compartment 2. When the fins 6′ of the part R′ secured to the said first compartment 2 are superimposed on rails (10) of the part R″, the orifices 8′ and 11 are also superimposed (see FIG. 3B) and the first compartment 2 communicates with the surrounding water. In this configuration, the first compartment 2 is isolated from the second compartment 3, the fins 10 and the fins 5′ close off the communication orifice between the two compartments 2 and 3.

The part R′ is secured to the part R and offset from the latter so that, when the part R is in the open position to allow communication between the first 2 and second 3 compartments, the fins 10 of the part R″ are juxtaposed with those of the part R′ so as to prevent communication between the surrounding water and the first compartment 2. The connection means 5 (rotary drawer comprising the parts R and R″) and the first closing means (part R′ and part R″) are therefore arranged so that one is in the said open position when the other is in the closed position and vice versa.

The part R″ also comprises closing/opening catches 12 which, by an impact on a fixed point, will cause the rotation of the part R″. In the present case, the fins are eight in number and the catches will therefore cause a rotation of the part R″ by a sixteenth of a turn with respect to the part R′, secured to the said first compartment 2.

By way of example, in this embodiment, the parts R and R′ each comprise eight fins 6, 6′ separated by eight orifices 8, 8′ and the passage from the communication position to the communication position is effected by a rotation of the movable part R by a sixteenth of a turn with respect to the fixed part R′ secured to the first compartment 2. It goes without saying that a rotation of 3/16, 5/16, 7/16, 9/16, 11/16, 13/16 or 15/16 would have the same effect and that these rotations therefore lie within the scope of the invention claimed. Likewise, each part R, R′ and R″ may comprise four or six fins separated by four or six orifices respectively and the passage from the communication position to the isolation position will then be effected by a rotation of the movable part R by an eighth or a twelfth of a turn with respect to the fixed part R′ secured to the first compartment 2.

FIG. 3A illustrates a variant of a movable element 1 of the device according to the invention. The first compartment 2 also comprises a second closure means 13 consisting of another rotary drawer (illustrated in FIGS. 4A and 4B). As can be seen in FIGS. 4A and 4B, the second closure means 13 is situated at the bottom of the said first compartment 2. The second closure means also comprises a fixed part 14 and a movable part 15. The fixed part 14 is secured to the first compartment 2 and the movable part 15 pivots on a pivot point 16 secured to the fixed part 14. The diameter of these parts 14 and 15 is substantially identical to the diameter of the said first compartment 2. Preferably, the parts 14 and 15 are identical to the parts R′ and R″ (without the part R) so as to easily synchronise the opening and closing and so as not to generate force stresses in the first compartment 2, and the number of fins and orifices are identical.

The said second closure means 13 and the first closure means R″ are arranged so as to be simultaneously in the closed or open position so that, when the first compartment 2 is isolated from the surrounding water by the first closure means R″, it is also isolated by the second closure means 13 and the first compartment 2 is in communication with the second compartment 3.

As can easily be seen in FIG. 1 or 2, the parts R′, R″ and the parts 14 and 15 are slightly curved at the lateral end so that the receptacle is formed by the aforementioned parts. The parts R′ and 14, which are the fixed parts, are connected by a flexible membrane 17. The parts R″ and 15 are the movable parts and are each connected to a catch 12 allowing rotation of it.

This being one embodiment, all other opening and closing means, known per se, can of course be used without departing from the scope of the invention (valves, tilting covers, sliding covers, etc).

As can be seen in FIG. 5, the device according to the invention comprises a transport track 19 immersed in the water comprising at least one descent section 19a and one ascent section 19b.

During descent, the first compartment 2 is isolated from the second compartment 3 and is in communication with the surrounding water since the first and second closure means are in the open position. The water therefore passes freely through the movable element 1. It should be recalled that the protective structure 9 is of the sleeve type, that is to say not closed. Advantageously, the said extensible second compartment 3 is fixed at one point to the said sleeve in order to hold it in the most favourable position.

When the said movable element 1 arrives at a predetermined depth (at the bottom of the descent section 19a), it surrounds a predetermined quantity of water present at the predetermined depth. At this predetermined depth, the rotation of the part R″ and of the part 15 is demanded and the first compartment 2 is isolated from the surrounding water. The first compartment 2 of the movable element 1 therefore confines a quantity of water taken off at the said predetermined depth. This confined water has a large quantity of dissolved gas, as mentioned previously. The rotation of the part R″ has taken place at the same time as the opening of the communication between the first 2 and second 3 compartment. The aforementioned opening therefore offers the dissolved gas a space to occupy, namely the second compartment 3. The gas will therefore start to expand during ascent and fill the second compartment 3. The density of the movable element 1 decreases since the gas is occupying a space (in the balloon 3) that causes an increase in volume for the same mass. The density decreases and the ascent of the movable element 1 commences and the buoyancy that it undergoes increases. The more the movable element 1 rises, the lower the pressure due to the depth, and the more the gas increases in volume and the more the gas dissolved in the water or incorporated resumes its gaseous form, or leaves the liquid phase. This phenomenon continues until the highest point of the ascent section 19b is arrived at.

When the movable element 1 is at the top, the rotation of the part 15 is demanded and the first and second compartments are together in communication with the surrounding water. This allows the expulsion of the gas and water relatively together. Advantageously, the expanded gas is released under the water, which has the advantage of completely emptying the second compartment of the gas expanded by the pressure of the surrounding water exerted on it. It can also be released when the second compartment is on the surface. Its high drain valve will then be kept open until the start of descent so that it completely empties under the effect of the entry into the water. Closure of the high drain being controlled by any means, for example a float of the WC flush type.

The rotation of the part R″ is controlled so as to isolate the second compartment 3 from the first compartment 2 before descent, to prevent the balloon 3 filling with water, and the cycle can commence once again.

The movable element 1 is secured to a belt 2 moving on the said transport track 19. In the embodiment illustrated, the belt 2 is supported during its movement by pulleys 21. The device according to the invention also comprises means 23 of transmitting the movement of the said movable element to at least one generator 22 capable of converting this movement into electrical energy. These transmission means are known per se and are here roughly shown schematically.

In the embodiment illustrated in FIG. 6, the movable elements 1 are connected to two identical belts 20 so as to keep the movable element 1 in the same position during its movement. This is because, during descent, the movable element 1 drives the movement of the belt 20. The movable element is preferably placed between the two belts in order not to interfere with the passage of the latter around pulleys.

The two movable elements illustrated are situated symmetrically on the belt so that the weight forces (gravity) balance each other and cancel each other out. It is the buoyancy that is exerted with a greater force on the movable element ascending which drives the movement of the belt, initiated by the kinetic energy and the gravity of a descending movable element.

In FIG. 1 or 2, it can also be seen that it is advantageous to provide a membrane 17 in the first compartment to allow a certain expansion due to the change between the different depths through which the device according to the invention passes and to profit from the flexibility that makes it possible to obtain a larger evaporation surface as soon as the pressure in the first compartment becomes greater than the external pressure. It is also possible to envisage a double wall that can be thinned mechanically for the purpose of obtaining as large an evaporation surface as possible.

Also, it is envisaged according to the invention providing vibration means 18 of the same type as those illustrated in FIG. 8, but in the first compartment so as to promote the expansion and vaporisation of the dissolved gases. For example, the vibration means would be agitators intended to increase the degassing rate. They can comprise blades connected together by springs and will be agitated by small jolts imparted to the assembly by passage over vibrators. The blades can also turn around a sealed communication spindle with, outside the movable element, a roller rubbing on a cable and therefore making the internal agitators turn continuously.

FIG. 2 illustrates a variant embodiment of a movable element according to the invention. In this variant, a compressible/extensible reservoir 25 is connected to the first compartment 2. The communication between the latter is controlled and may for example be a rotary drawer or a valve (not illustrated). In the variant, the compressible/extensible reservoir 25 is a piston. This reservoir 25 comprises a predetermined quantity of atmospheric air. As descent takes place, the air that it contains will be subjected to the corresponding pressure at the depth reached by the movable element (1), and therefore compressed. This is because the pressure prevailing at the predetermined depth is exerted in all existing directions and will compress the quantity of air (or any other compressible fluid) contained. Consequently the arm of the piston will slide in the direction of compression until equilibrium of pressures is reached.

The quantity of atmospheric air contained is small compared with the weight of the assembly so as not to prevent the descent of the movable element and the compressible/extensible reservoir 25 also has a closable orifice (not shown) that allows renewal of the atmospheric air contained.

At the aforementioned predetermined depth, the first compartment (2) is filled with water. The upper surface of the volume of water contained therefore coincides with that of the first compartment 2 of the movable element (1). This is because, the first compartment 2 being immersed, the surrounding water would occupy the space available therein.

In order to increase the exchange surface and to facilitate the exsolution of the dissolved gas, at the predetermined depth, communication between the compressible/extensible reservoir 25 and the first compartment 2 is achieved. The result of this is an entry of the compressed air from the compressible/extensible reservoir 25 into the first compartment 2 of the movable element 1 by means of a porous material 34.

As can be seen in FIG. 2, the reservoir is connected to a porous material 34 bonded to the fins of the movable wheel 15 of the rotary drawer. A hollow central spindle 35 is also present. The latter is secured to the movable wheel 13 of the rotary drawer. The porous material 34 is situated outside the hollow spindle and the part in the hollow spindle 35 is impervious to gas. Another central spindle 36 for its part is secured to the fixed wheel R′ and R. The two central spindles 35 and 36 are connected by a screw thread. When the movable wheel 15 makes a rotation of a sixteenth of a turn for example, the hollow central spindle 35 also makes a rotation which has the effect of moving the rotary drawer at the top away from that of the bottom (a separation also made possible by the flexible membranes 17). This separation by means of the flexible membranes 17 allows an increase in the volume of this first compartment and consequently, the gas having a tendency to be directed upwards, the exchange surface of the water contained is reduced (the volume of the first compartment increases and therefore the level descends) and consequently the exchange is improved. In addition, given the particular form of the walls, the exchange surface is increased and the exsolution even more promoted.

The bubbles created by the expansion of the dissolved gas (which undergoes exsolution) and/or of the compressed air, and by the porous elements, in their turn become exchange surfaces as well as an agitator, and this synergetically amplifies the exsolution by the known phenomenon of the bubbles in a sparkling liquid which increase in size as they rise).

FIG. 6 illustrates a particularly preferential embodiment according to the invention. The functioning of the device is similar to that mentioned for FIG. 5. The transport track 19 and therefore the descent section 19a, the ascent section 19b, the substantially horizontal top section 19c and the substantially horizontal bottom section 19d. In addition, the transport track comprises a plurality of stages 19e fulfilling the role of decompression stage in order to improve the vaporisation of dissolved gas contained in the water. Several movable elements 1 are driven one by the other, that is to say those situated in horizontal levels 19c, d, e are driven by those ascending or descending. The movable elements 1 move in the water, secured to each other by means of the belt 20. At each stage vibration means can be seen, which increase the efficiency of the evaporation of dissolved gas. Advantageously, these levels can be rising slightly, so that the stages do not become energy consumers.

FIG. 7 illustrates an experimental device that made it possible, for a predetermined quantity of water, to quantify the quantity of dissolved gas able to undergo exsolution.

The experimental device comprises a first reservoir 26 with a pipe 27 over it. The pipe 27 has a valve 28 having an open position and a closed position. In the open position, the reservoir 26 is in communication with the pipe 27. Between the reservoir 26 and the valve 28, the pipe 27 comprises a bypass 29. The top part of the pipe 27 ends up in a receptacle 30 having a cross section greater than that of the pipe and in which the bypass 29 also ends.

The bypass 29 also comprises a branch terminating in an extensible receptacle 31 (a balloon).

The receptacle 30 is provided with a closure cover 32.

The cover 32 has been removed and the valve 28 closed. A predetermined quantity of water X has been poured into the pipe 27 and equilibrium has been left to establish. The water in the pipe 27 has a column height H. The atmospheric gas is in fact left to dissolve in the water contained in the pipe 27 (if the level of the water contained in the column reaches the bottom of the receptacle 30, the exchanges and therefore the dissolution of the atmospheric gas is accelerated through increase of the exchange surface (situation A).

After approximately one hour (one quarter if the level of the water contained in the column reaches the bottom of the receptacle 30), the cover 32 has been replaced on the receptacle 30, the receptacle 31 being in the “deflated” or “compressed” state. The valve 28 is opened and the water contained in the pipe 27 flows into the reservoir 26 and at this moment has a height h. The gas dissolved in the water is allowed to undergo exsolution (situation B).

Since the system is closed, the gas that exsolves will increase the volume of the extensible receptacle 31 (the balloon) and the latter will inflate under the effect of the exsolution (situation C).

It will then be possible to measure the volume of gas exsolved for example by immersing the balloon in a known volume of water. The results obtained are presented in a table below.

TABLE

| | | | | Volume of gas |
|---|---|---|---|---|
| | | | | expected |
| Quantity of | | | Volume of | according to |
| water | Height of | Height of | gas | approximation of |
| X (litres) in | column H | column h | exsolved | Henry's law |
| the pipe | (cm) | (cm) | (litres) | (litres) |
| 27.7 | 280 | 2.11 | 60 | 0.46 |
| 0.45 | 45 | 2.5 | 0.54 | 0.0075 |
| 1.00 | 90 | 5 | 1.03 | 00.17 |

As can be seen, the quantities of gas exsolved are very high compared with the quantity of water used and with respect to the quantity expected.

In addition, from this example, it can be expected that the quantity of gas that will undergo exsolution from water present at the said predetermined depth, for example 250 or 300 m, to be very high and consequently to cause the movable elements undergoing a proportional buoyancy (generating an even greater production of electricity) to rise. This device has been developed to illustrate particularly the efficacy of the device according to the invention. The water situated at the bottom of the column (in the pipe 27) is subject to a pressure corresponding to the height of the column H, in the same way as water taken off in the depths of the sea at the predetermined depth. Decanting into a receptacle having a much greater cross section, which therefore subjects the said water to a lower pressure corresponding to the height h (<H), simulates the ascent of the movable element.

The quantity of gas that spontaneously exsolves corresponds to that which would be harvested in the balloon (second compartment).

It therefore seems very clear that the device according to the invention is particularly effective for creating a movement for driving a generator and therefore producing electricity.

Naturally the present invention is in no way limited to the embodiments described above and many modifications can be made thereto without departing from the scope of the accompanying claims.

Alternatively, the vibration means comprise porous elements that promote exsolution.

Likewise, by way of example, the top part of the second compartment comprises an exit orifice for the gases. In this case, the part 15 and the part R″ close simultaneously rather than consecutively and the gases escape through the outlet orifice when the movable element 1 enters the horizontal top section.

In another variant, it is advantageous to provide for the parts R′ and R″ to have a thickness that is reduced at the centre and greater at the ends. In this case, the parts R′ and R″ will serve as a guide means for the gases by means of the slope created by the reduced thickness at the centre. This also prevents stagnation of the expanded gas in the first compartment.

Provision is also made according to the invention for the said two compartments of the movable element to be a single compartment, the features of which are to be able to change volume.

1. Method of producing electricity, comprising
movement in water of a plurality of movable elements (1) integral with each other with respect to movement, each having a first compartment (2) and a second compartment (3) connected to each other so as to allow alternately isolation and communication with each other, this movement comprising, for each movable element (1):
descent to a predetermined depth, during which the first compartment (2) is isolated from the said second compartment (3), comprising:
opening of a passage towards the outside of the said first compartment (2), which thus contains water in which the said movable element (1) is immersed and in which a gas is dissolved, the gas in the said first compartment (2) having, at least at the said predetermined depth, a predetermined pressure, the said movable element (1) having at the said predetermined depth a specific gravity corresponding to the said predetermined pressure, and
closure of the said passage at the said predetermined depth, the said descent being simultaneous with an ascent of at least one other movable element,
a putting of said first compartment (2) in communication with the said second compartment (3), at the said predetermined depth,
ascent of the said at least one movable element (1) initially by driving and next by progressive reduction of the water pressure with expansion of the said gas in the said second compartment (3) and a reduction of the said specific gravity, the said ascent being simultaneous with a descent of the said at least one other movable element (1), and
conversion of this movement into electrical energy.

2. Method according to claim 1, also comprising, between the said descent and the said ascent of each movable element (1), a substantially horizontal movement of the said movable element (1) during which the said putting in communication of the two compartments (2, 3) takes place.

3. Method according to claim 1, also comprising, between the said ascent and the said descent of each movable element, a substantially horizontal movement of the said movable element (1) during which the said isolation of the said second compartment (3) with respect to the first compartment (2) takes place.

4. Method according to claim 1, also comprising an agitation of the water contained in the said first compartment (2) so as to facilitate the expansion of the gas dissolved in this water.

5. Method according to claim 1, in which the said expanded gas is expelled from the said movable element after the ascent of the said movable element (1).

6. Method according to claim 1, also comprising, before the said ascent, an introduction of a quantity of air also under pressure through a porous material (34).

7. Electricity production device comprising:
a transport track (19) immersed in the water, comprising at least one descent section (19a) and an ascent section (19b),
a plurality of movable elements (1) integral with respect to movement on the said transport track (19), each movable element (1) comprising a first (2) and a second (3) compartment and connection means (5) affording communication or isolation of these compartments (2, 3), and
means of transmitting the movement (23) of the said movable element to at least one generator (22) capable of converting this movement into electrical energy.

8. Device according to claim 7, in which the said transport track (19) also comprises, between the said descent section (19a) and the said ascent section (19b), a substantially horizontal top section (19c) situated close to an interface between the said water and a surrounding atmosphere and/or between the said descent section (19a) and the said ascent section (19b), a substantially horizontal bottom section (19d) situated at a predetermined depth.

9. Device according to claim 7, in which the said connection means (5) consists of a rotary drawer.

10. Device according to claim 7, comprising a first closure means (R″) and a second closure means (13), both arranged so as to allow a passage of water into the said first compartment (2), the said closure means (R″, 13) each having an open position and a closed position, the said first (R″) and the said second (13) closure means being arranged to be in the said open position when the said connection means (5) are in the isolation position and to be in the said closed position when the connection means (5) are in the communication position.

11. Device according to claim 7, in which the said second compartment (3) is an extensible element protected by a protective structure (9) of the sleeve type.

12. Device according to claim 7, also comprising vibration elements (18).

13. Device according to claim 6, also comprising a porous material placed in the first compartment, connected to a pressurised gas reservoir (25).
